(19) United States
(12) Patent Application Publication
(10) Pub. No.: US 2019/0150160 A1
(43) Pub. Date: May 16, 2019

(54) BASE STATION DEVICE AND CONTROL METHOD FOR BASE STATION DEVICE

(71) Applicant: FUJITSU LIMITED, Kawasaki-shi (JP)

(72) Inventors: Noboru KOBAYASHI, Tokorozawa (JP); Tadashi Nakamura, Yokohama (JP)

(73) Assignee: FUJITSU LIMITED, Kawasaki-shi (JP)

(21) Appl. No.: 16/175,554

(22) Filed: Oct. 30, 2018

(30) Foreign Application Priority Data
Nov. 15, 2017 (JP) 2017-220226

(51) Int. Cl. H04W 72/08; H04W 24/08

(52) U.S. Cl. CPC H04W 72/085; H04W 88/08; H04W 24/08

(57) ABSTRACT

A base station device is implemented on a general purpose server by using software and includes a memory and a processor coupled to the memory. The processor executes a process including: collecting information indicating usage states of resources in the general purpose server; deciding, based on the collected information, combinations of uplink data rates and downlink data rates that are feasible in free space in the resources in the general purpose server; and adjusting communication with user equipment so as not to exceed a combination of an uplink data rate and a downlink data rate out of the combinations of the uplink data rates and the downlink data rates.

### CROSS-REFERENCE TO RELATED APPLICATION

This application is based upon and claims the benefit of priority of the prior Japanese Patent Application No. 2017-220226, filed on Nov. 15, 2017, the entire contents of which are incorporated herein by reference.

### FIELD

The embodiment discussed herein is related to a base station device and a control method for a base station device.

### BACKGROUND

In recent years, communication using a Long Term Evolution (LTE) system is becoming the most frequently used system from among cellular communication systems. In LTE communication system, a transmission speed of user equipment connected to a base station device is determined for each subframe at intervals of, for example, 1 ms. In the base station device, a layer 1 (physical layer) sends and receives data to and from the user equipment in units of subframes at intervals of, for example, 1 ms. Thus, an amount of processing in the layer 1 is significantly great and electrical power consumption consumed by the processing performed by the layer 1 is thus significantly large. Consequently, the electrical power consumption in the entire base station device becomes large.

Thus, studies have been conducted on a configuration in which a base station device is to be running on a general purpose server by using software (for example, Japanese National Publication of International Patent Application No. 2003-520551). As a technology for implementing a configuration by using software, there is a known technology, such as a software-defined networking (SDN) technology and a network function virtualization (NFV) technology. In recent years, regarding the technology described above, the introduction of the technology with respect to, in addition to a core network, a base station device, in particular, to the layer 1 (physical layer). A central processing unit (CPU) is used in the general purpose server. The CPU is the most expensive part from among the components constituting the server and occupies a large volume in terms of electrical power consumption. Thus, there is a need to efficiently use the CPU resources, i.e., the resources in the general purpose server.

In uplink (UL) communication that is performed from the user equipment to the base station device, the layer 1 in the base station device performs processes, such as channel estimation, data equalization, data demodulation, and data decoding. Thus, in the base station device, an amount of processing in the UL is significantly greater than an amount of processing in a downlink (DL) that is from the base station device to the user equipment. In contrast, the number of usage patterns of the user equipment used in communication in the DL is greater than that in the UL. For example, in recent years, communication of distributing (transmitting) data, such as moving images or online games, from the base station device to the user equipment is increased. Thus, if the base station device is implemented on the general purpose server by using software, software is developed assuming that communication is performed at the maximum data rate in both the UL and the DL.

However, a case in which both the UL communication and DL communication is performed at the maximum data rate is less likely to occur. When considering that the number of usage patterns of the user equipment used in the DL is greater than that in the UL, it is rarely the case that both UL communication and DL communication are simultaneously used at the maximum data rate. For example, although the number of usage patterns of the user equipment used in DL communication greater than that used in UL communication, it is useless to prepare the CPU resources (resources in the general purpose server) such that both the UL communication and the DL communication are simultaneously used at the maximum data rate.

Furthermore, when implementing the base station device on the general purpose server by using software, it is conceivable to use the general purpose server as, for example, a data center. Namely, in addition to the processes performed by the base station device, there may also be a case in which the processes to be performed by the data center are allowed to perform in the general purpose server. In this case, there may sometimes be a case in which the CPU resources that can be used by the base station device vary and thus there is a need to efficiently utilize the resources.

The technology disclosed in the present invention efficiently utilizes the resources.

### SUMMARY

According to an aspect of an embodiment, a base station device is implemented on a general purpose server by using software and includes a memory and a processor coupled to the memory. The processor executes a process including: collecting information indicating usage states of resources in the general purpose server; deciding, based on the collected information, combinations of uplink data rates and downlink data rates that are feasible in free space in the resources in the general purpose server; and adjusting communication with user equipment so as not to exceed a combination of an uplink data rate and a downlink data rate out of the combinations of the uplink data rates and the downlink data rates.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of a radio communication system in which a base station device according to an embodiment is used;

FIG. 2 is a block diagram illustrating an example of a configuration of the base station device according to the embodiment;

FIG. 3 is a block diagram illustrating an example of a layer configuration (basic configuration) according to the base station device according to the embodiment;

FIG. 4 is a diagram illustrating the relationship between UL throughput and DL throughput;

FIG. 5 is a diagram illustrating the relationship between UL throughput and DL throughput;

FIG. 6 is a diagram illustrating the relationship between UL throughput and DL throughput;

FIG. 7 is a block diagram illustrating an example of a layer configuration of the base station device according to the embodiment;

FIG. 8 is a diagram illustrating an example of combinations, in the base station device according to the embodiment, of data rates that can be used for communication in an UL and a DL with respect to an available CPU resource percentage and illustrating an example of analysis information;

FIG. 9 is a diagram illustrating the relationship between UL throughput and DL throughput in the base station device according to the embodiment; and

FIG. 10 is a flowchart illustrating an example of a process performed by the base station device according to the embodiment.

### DESCRIPTION OF EMBODIMENTS

Preferred embodiments of the present invention will be explained with reference to accompanying drawings. Furthermore, the embodiments described below do not limit the disclosed technology.

Radio Communication System

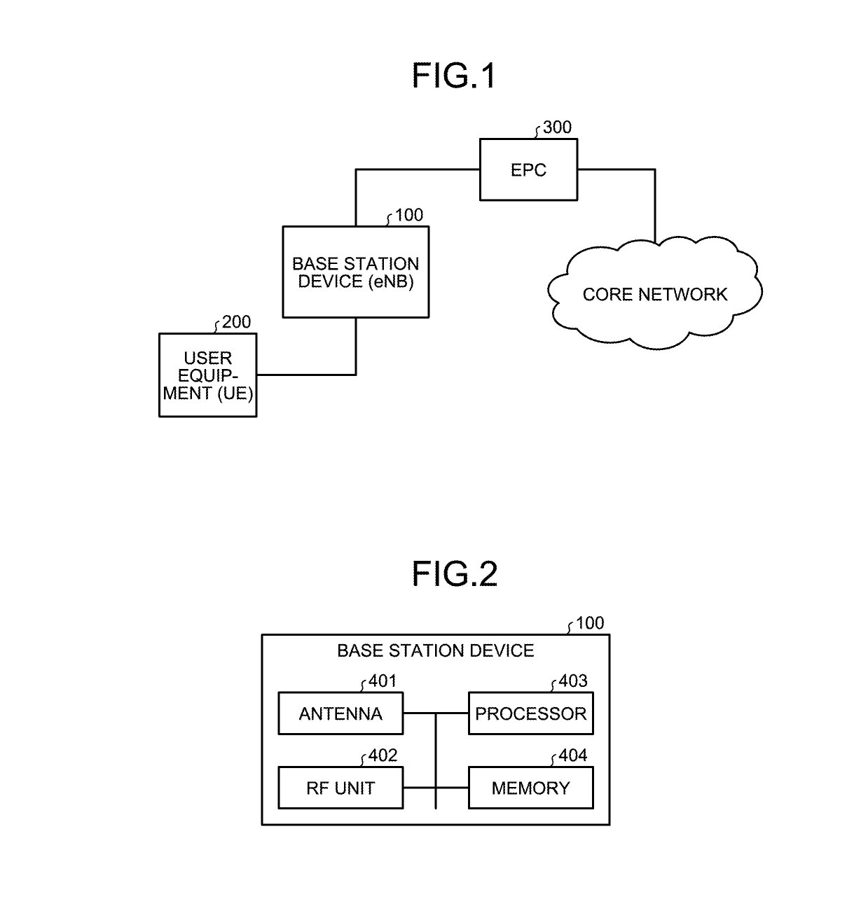

FIG. 1 is a block diagram illustrating an example of a configuration of a radio communication system in which a base station device according to the embodiment is used. The radio communication system illustrated in FIG. 1 is a cellular communication system used in LTE. The radio communication system includes a base station device 100 and user equipment 200.

The base station device 100 is, for example, an eNB used in LTE. The user equipment 200 is, for example, UE used in LTE. For example, an EPC 300 that is a mobile core network is provided in a higher rank of the base station device 100.

The base station device 100 is connected to a core network (Internet) via the EPC 300. The base station device 100 terminates a radio access of the user equipment 200 and allows the user equipment 200 to perform an Internet access. The embodiment provides, in a case where a plurality of the base station devices 100 is packaged on a general purpose server, a system in which the resources (for example, CPU resources) in the general purpose server can be efficiently used.

Configuration of the Base Station Device 100

FIG. 2 is a block diagram illustrating an example of a configuration of the base station device 100 according to the embodiment. The base station device 100 includes an antenna 401, a radio frequency (RF) unit 402, a processor 403, and a memory 404.

An example of the processor 403 includes a CPU, a digital signal processor (DSP), a field programmable gate array (FPGA), or the like. In the embodiment, it is assumed that the processor 403 is a CPU.

An example of the memory 404 includes a random access memory (RAM), such as a synchronous dynamic random access memory (SDRAM); a read only memory (ROM); a flash memory; or the like. For example, in the memory 404, various programs, such as programs used to implement the function of the base station device 100, is stored. Then, the processor (CPU) 403 implements the function of the base station device 100 by reading the programs stored in the memory 404 and cooperating with the RF unit 402 or the like.

Layer Configuration (Basic Configuration) of the Base Station Device 100

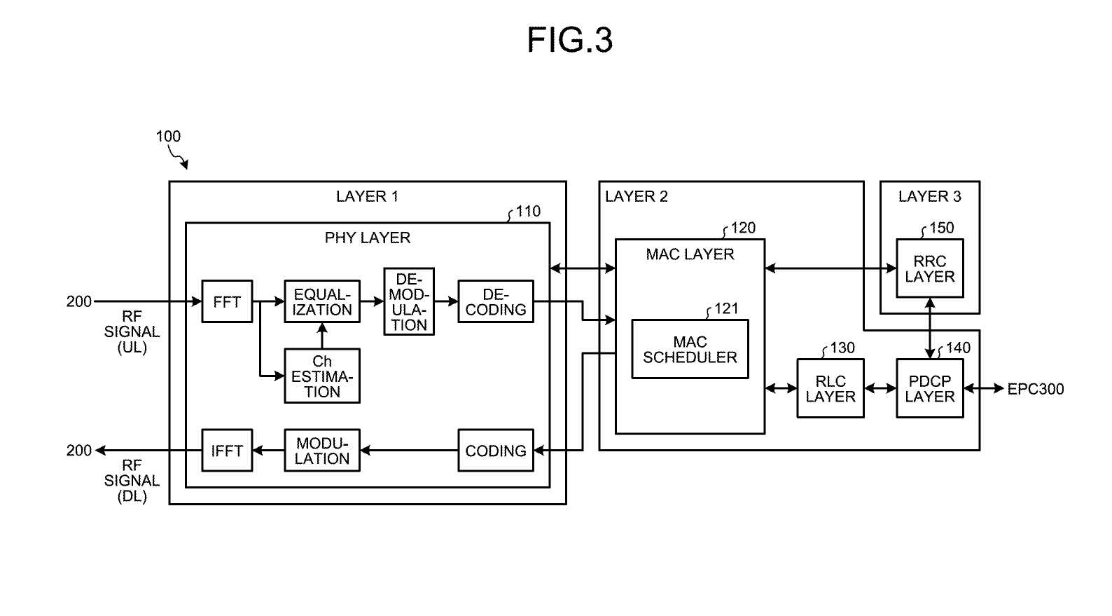

FIG. 3 is a block diagram illustrating an example of a layer configuration (basic configuration) according to the base station device 100 according to the embodiment. The base station device 100 has the layer 1, a layer 2, and a layer 3.

The layer 3 has a radio resource control (RRC) layer 150. The RRC layer 150 sends and receives control data, such as mobility management or call control, to and from the base station device 100 and the user equipment 200. For example, the RRC layer 150 outputs the control data to the layer 2. Furthermore, the RRC layer 150 inputs the control data received from the layer 2.

The layer 2 has a medium access control (MAC) layer 120, a radio link control (RLC) layer 130, and a packet data convergence protocol (PDCP) layer 140.

The PDCP layer 140 outputs user data received from the core network to the RLC layer 130 and outputs control data output from the RRC layer 150 to the RLC layer. Furthermore, the PDCP layer 140 sends the user data output from the RLC layer 130 to the core network and outputs the control data output from the RLC layer 130 to the RRC layer 150. Here, the PDCP layer 140 stores the data in the buffer held by the own PDCP layer 140 such that the data (the user data and the control data) is correctly transmitted and then performs processes, such as IP packet header compression, decompression, and encryption, on the data stored in the buffer.

The RLC layer 130 outputs, to the MAC layer 120, the data (the user data and the control data) output from the PDCP layer 140. Furthermore, the RLC layer 130 outputs, to the PDCP layer 140, the data output from the MAC layer 120. Here, the RLC layer 130 stores the data in the buffer held by the own RLC layer 130 such that the data is correctly transmitted and performs processes, such as retransmission control, overlap detection, and order sorting, on the data stored in the buffer.

The MAC layer 120 outputs, to the layer 1, the data (the user data and the control data) output from the RLC layer 130. Furthermore, the MAC layer 120 outputs, to the RLC layer 130, the data output from the layer 1. Here, the MAC layer 120 performs the process, such as radio resource allocation, channel mapping, hybrid automatic repeat request (HARQ) retransmission control, based on the control data.

The MAC layer 120 includes a MAC scheduler 121.

Here, the MAC layer 120 receives a notification indicating a retention volume of data stored in the buffer in each of the pieces of the user equipment 200 as a data buffer retention volume in an uplink (hereinafter, referred to as an “UL”) from each of the pieces of the user equipment 200 via the layer 1. Furthermore, the MAC layer 120 receives a notification indicating a retention volume of data stored in a buffer in a higher layer of the MAC layer 120 as a data buffer retention volume in a downlink (hereinafter, referred to as a “DL”) from the RLC layer 130. The buffer in a higher layer of the MAC layer 120 mentioned here is a buffer in the PDCP layer 140 and the RLC layer 130.

Then, the MAC scheduler 121 in the MAC layer 120 decides the data rate in the UL and the DL based on the data buffer retention volume in the UL and the DL. Then, based on the decided data rate in the UL and the DL, the MAC scheduler 121 performs scheduling of communication in the UL and the DL between the base station device 100 and the user equipment 200. Namely, the MAC scheduler 121 performs scheduling of communication to be performed by the layer 1.

The layer 1 has a physical layer 110. Hereinafter, the physical layer 110 is referred to as the PHY layer 110. The PHY layer 110 corresponds to the RF unit 402 described above.

The PHY layer 110 receives a radio signal (RF signal) in the uplink (UL) sent from the user equipment 200. Then, the PHY layer 110 performs fast Fourier transformation (FFT) on the received radio signal. Consequently, the received radio signal is subjected to orthogonal frequency division multiplexing (OFDM) demodulation. Namely, the received radio signal is converted from a time domain signal to a frequency domain signal.

In the signal that has been subjected to OFDM demodulation, the data (the user data and the control data), a pilot signal, and the like are included. The pilot signal is, for example, a signal, such as a reference signal used in LTE. Furthermore, in the signal that has been subjected to OFDM demodulation, information, such as a data buffer retention volume in the UL and the quality of a radio channel, is included. An example of the quality of the radio channel includes the channel quality indicator (CQI) that is a radio quality index.

The PHY layer 110 estimates a channel (Ch) based on the pilot signal. Then, the PHY layer 110 uses the estimation result of the channel and performs equalization and demodulation on the data. Then, the PHY layer 110 decodes the demodulated data.

The data (the user data and the control data) decoded by the PHY layer 110 is output to the MAC layer 120. The control data is sent from the MAC layer 120 to the RRC layer 150 via the RLC layer 130 and the PDCP layer 140. The user data is sent from the MAC layer 120 to the antenna 401 (FIG. 2) via the RLC layer 130 and the PDCP layer 140. The user data sent from the antenna 401 is sent to the core network via a gateway (GW) in the EPC 300.

The user data sent from the core network is received by the PDCP layer 140 in the base station device 100 via the GW in the EPC 300 and is sent to the MAC layer 120 via the RLC layer 130. Furthermore, the control data sent from the RRC layer 150 is received by the PDCP layer 140 in the base station device 100 and is sent to the MAC layer 120 via the RLC layer 130. The MAC layer 120 converts the data (the user data and the control data) to the format that can be processed in the layer 1 and sends the data to the PHY layer 110 in the layer 1.

The PHY layer 110 performs encoding on the data received from the layer 2 in accordance with an instruction received from the MAC layer 120. The PHY layer 110 modulates the encoded data by using a modulation technique specified by the MAC layer 120. Then, the PHY layer 110 performs inverse Fast Fourier transformation (IFFT) on the modulated data. Consequently, the modulated data is subjected OFDM modulation. Namely, the modulated data is transformed from a modulation symbol in the frequency domain to a valid symbol in the time domain. The PHY layer 110 sends the signal that has been subjected to OFDM modulation to the user equipment 200 from the antenna 401 (FIG. 2) as a radio signal (RF signal) in the downlink (DL).

Problems

In the base station device 100, the layer 1 (the PHY layer 110) sends and receives data to and from the user equipment 200 in units of subframes at intervals, for example, 1 ms. Thus, an amount of processing in the layer 1 is significantly great and the electrical power consumption consumed by the process performed by the layer 1 is thus significantly large. Consequently, the electrical power consumption in the entire base station device 100 becomes large.

For example, in uplink (UL) communication that is performed from the user equipment 200 to the base station device 100, the layer 1 in the base station device 100 performs processes, such as channel estimation, data equalization, data demodulation, and data decoding. Thus, in the base station device 100, an amount of processing in the layer 1 performed on communication in the UL is significantly greater than that in the downlink (DL) that is from the base station device 100 to the user equipment 200.

In contrast, the number of usage patterns of the user equipment 200 used in the DL communication is greater than that in the UL communication. For example, in recent years, communication in which data, such as moving images or online games, is distributed (transmitted) from the base station device 100 to the user equipment 200 is increased.

Thus, when the base station device 100 is implemented on the general purpose server by using software, software is developed assuming that communication is performed at the maximum data rate in both the UL and the DL.

However, a case in which both the UL communication and DL communication is performed at the maximum data rate is less likely to occur. When considering the number of usage patterns of the user equipment 200 used in the DL is greater than that used in the UL, it is rarely the case that both UL communication and DL communication are simultaneously used at the maximum data rate. For example, although the number of usage patterns of the user equipment 200 used in DL communication greater than that used in UL communication, it is useless to prepare the CPU resources (resources in the general purpose server) such that both the UL communication and the DL communication are simultaneously used at the maximum data rate.

Furthermore, when implementing the base station device 100 on the general purpose server by using software, it is conceivable to use the general purpose server as, for example, a data center. Namely, in addition to the processes performed by the base station device 100, there may also be a case in which the processes to be performed by the data center are allowed to perform in the general purpose server. In this case, there may sometimes be a case in which the CPU resources that can be used by the base station device 100 vary and thus there is a need to efficiently utilize the resources.

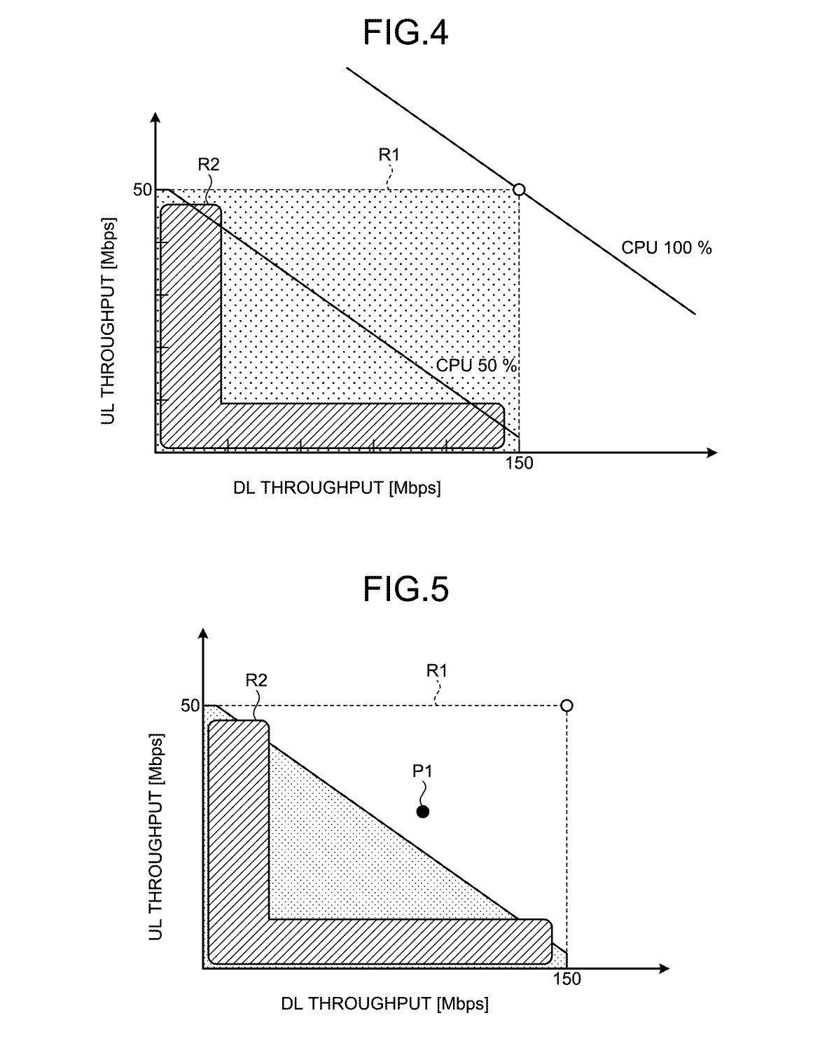

FIGS. 4 to 6 are diagrams each illustrating the relationship between UL throughput and DL throughput. In FIGS. 4 to 6, the horizontal axis represents throughput [Mbps] in the DL and the maximum value of the data rate used for communication in the DL is 150 Mbps. The vertical axis represents throughput [Mbps] in the UL and the maximum value of the data rate used for communication in the UL is 50 Mbps.

In order to support communication simultaneously used in the UL and the DL at the maximum data rate, the range of a region R1 illustrated in FIG. 4 needs to be covered. In contrast, a region of combinations of mainly used data rates in the UL and the DL is a region R2 illustrated in FIG. 4. When implementing the base station device 100 by using software, all of the processes can be performed in a CPU without the processes performed by the layer 1 (the PHY layer 110) depending on hardware, thereby an amount of processing in the base station device 100 can be simply represented by a usage rate of the CPU.

In FIG. 4, it is assumed that the CPU usage rate that covers the range of the region R1 in which the UL and the DL are simultaneously used at the maximum data rate is 100%. In this case, it is found that the CPU usage rate that covers the range of the region R2 of combinations of the mainly used data rates in the UL and the DL is a half of the CPU usage rate that covers the range of the region R1, i.e., 50.0%. Thus, it is possible to set the performance of the CPU to ½ on the condition that supports the region R2 of combinations of the mainly used data rates in the UL and the DL.

In contrast, if the performance of the CPU is set to ½, there may sometimes be a case in which a process is not able to be performed at a point P1 in which scheduling has been performed by the MAC layer 120. For example, as illustrated in FIG. 5, it is assumed that, as the point P1, the data rate used in UL communication is 30 Mbps and the data rate used in DL communication is 90 Mbps. In this case, regarding the above described scheduled UL communication and DL communication (the UL: 30 Mbps and the DL: 90 Mbps), it is not possible to cover the range of the region R2. If a process is started under this condition, it is not possible to finish the process within a predetermined period and, in the worst case, the system may possibly go down.

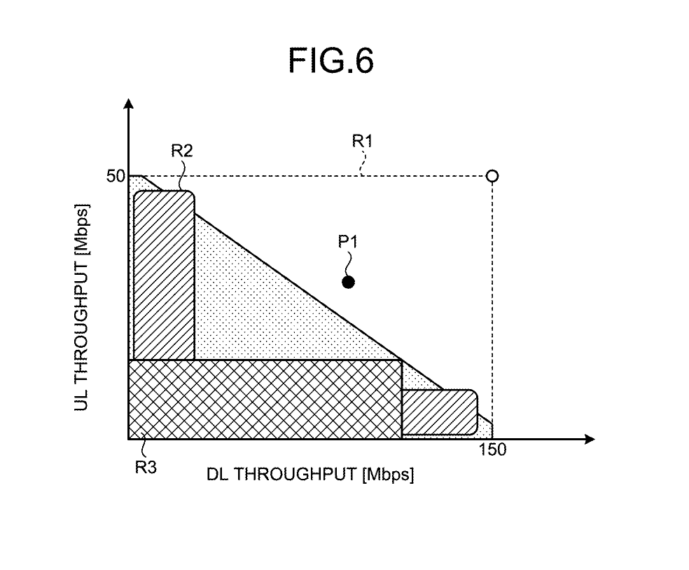

As a method for avoiding this state, as indicated by a region R3 illustrated in FIG. 6, there is a method for previously limiting the scheduling. This method is easily feasible; however, regarding the above described scheduled UL communication and DL communication (the UL: 30 Mbps and the DL: 90 Mbps), it is not possible to cover the range of the region R3. If a process is started under this condition, it is not possible to secure a needed transmission speed and thus the quality of service is degraded.

Furthermore, as described above, in the base station device 100, the MAC scheduler 121 in the MAC layer 120 in the layer 2 decides the data rates in the UL and the DL based on only a data buffer retention volume in each of the UL and the DL. Then, based on the decided data rates in the UL and the DL, the MAC scheduler 121 performs scheduling of UL communication and DL communication, which is performed by the layer 1, between the base station device 100 and the user equipment 200. Thus, if the layer 1 that supports the mainly used region (for example, the region R2 or the region R3) is packaged in the base station device 100, the layer 2 may possibly perform, based on the data rate that is not able to be supported by the layer 1, scheduling of the UL communication and the DL communication.

Layer configuration of the base station device 100 (configuration that solves the above described problem)

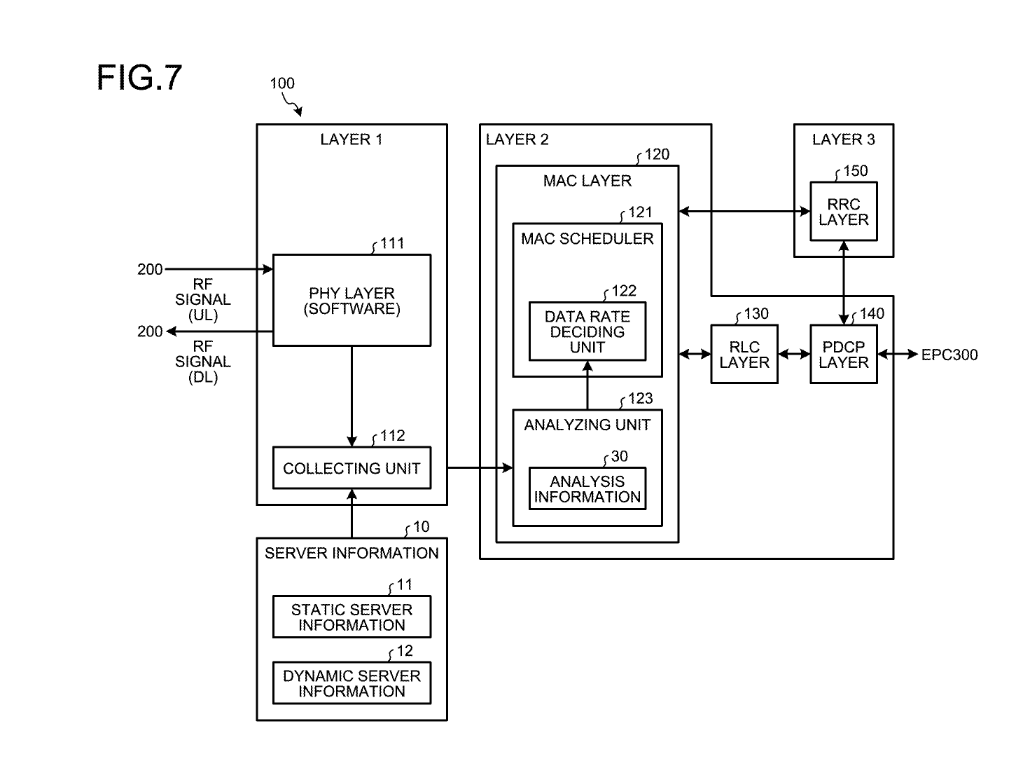

FIG. 7 is a block diagram illustrating an example of a layer configuration of the base station device 100 according to the embodiment. In FIG. 7, regarding components overlapped with those illustrated in FIG. 3, descriptions thereof will be omitted.

As illustrated in FIG. 7, the layer 1 has a PHY layer 111 and a collecting unit 112.

The PHY layer 111 is constituted by software. Namely, the PHY layer 111 implements the PHY layer 110 described above on the general purpose server by using software. Here, the processes performed by the PHY layer 111 are the same as those performed by the PHY layer 110 described above.

The collecting unit 112 collects processing time from the PHY layer 111. In the processing time, processing time used for the PHY layer 111 to perform uplink (UL) communication and processing time used for the PHY layer 111 to perform downlink (DL) communication are included.

Furthermore, the collecting unit 112 collects server information 10 indicating the usage states of the resources (for example, CPU resources) in the general purpose server. In the server information 10, static server information 11 and dynamic server information 12 are included.

The static server information 11 is server information that is static and that does not vary. For example, an example of the static server information 11 includes information on CPU specifications, setting of an operating system (OS), and the like.

The dynamic server information 12 is server information that dynamically varies and is, for example, information indicating the current load state of the CPU. Here, the load state is, for example, a state in which a process to be performed in the data center is being performed in the general purpose server.

Furthermore, the load state mentioned here includes, for example, a state in which a process to be performed in an application layer (layer 7) is being performed in the general purpose server or a state in which the other applications are being performed in the general purpose server. An example of the other application includes virtualization software called “Docker”.

Furthermore, the load state mentioned here includes, for example, a state in which a program is being executed in the general purpose server. An example of the program includes a program (program used for a test) that is used, for example, by the collecting unit 112 to collect the server information 10 or a program (program used for evaluation) that is used to evaluate the server information 10 collected by the collecting unit 112.

The collecting unit 112 collects the above described server information 10 and the processing time at intervals of predetermined time (for example, 10 ms) and outputs the collected server information 10 and the processing time to the layer 2.

As illustrated in FIG. 7, in the layer 2, the MAC layer 120 further includes an analyzing unit 123. Furthermore, in the MAC layer 120, the MAC scheduler 121 includes a data rate deciding unit 122.

The analyzing unit 123 receives the server information 10 and the processing time that are output from the collecting unit 112. The analyzing unit 123 analyzes, based on the received server information 10 and the processing time, free space in the resources (CPU resources) in the general purpose server.

For example, the analyzing unit 123 analyzes, based on the server information 10 and the processing time, the usage rate (CPU usage rate) of the CPU resources that are currently being used in the general purpose server. Hereinafter, the unit of the CPU usage rate is represented by %. Then, the analyzing unit 123 calculates the value obtained by subtracting the CPU usage rate [%] from 100 [%] as the percentage [%] of the available CPU resources. Namely, the analyzing unit 123 analyzes the free space in the CPU resources.

Then, the analyzing unit 123 decides combinations of the maximum data rates (the maximum rates) in the ULs and the DLs that are feasible in the analyzed free space in the CPU resources (percentage of the available CPU resources). The analyzing unit 123 is an example of a “first deciding unit”. Specifically, the analyzing unit 123 generates analysis information 30 based on the percentage of the analyzed available CPU resources. The analysis information 30 is information indicating combinations of the percentages of the available CPU resources, the feasible maximum rates in the ULs and the DLs, and the processing time needed when the PHY layer 111 performs communication in the ULs and the DLs at the corresponding maximum rates.

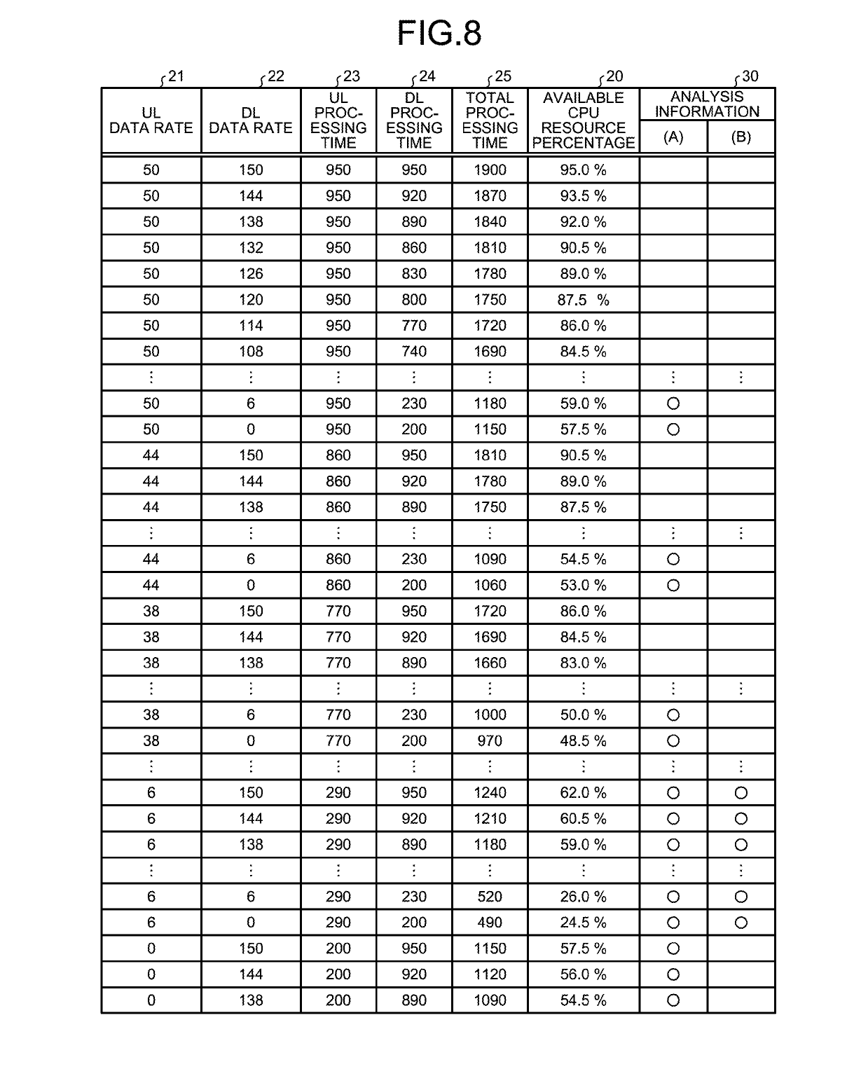

FIG. 8 is a diagram illustrating an example of combinations, in the base station device 100 according to the embodiment, of data rates that can be used for communication in an UL and a DL with respect to an available CPU resource percentage and illustrating an example of analysis information 30.

In FIG. 8, an available CPU resource percentage 20 represents a percentage [%] of each of available CPU resources, i.e., free space in the CPU resources. Each of an UL data rate 21 and a DL data rate 22 represents the feasible maximum rate [Mbps] in the UL and the DL at the available CPU resource percentage 20. Each of UL processing time 23 and DL processing time 24 represents the processing time [ms] needed when the PHY layer 111 performs UL communication and DL communication at the UL data rate 21 and the DL data rate 22, respectively. Total processing time 25 represents total time [ms] of the UL processing time 23 and the DL processing time 24.

For example, it is assumed that the available CPU resource percentage 20 is 95.0%. In this case, the analyzing unit 123 generates the analysis information 30 indicating combinations of sets of the available CPU resource percentage 20 that is equal to or less than 95.0%, the UL data rate 21, the DL data rate 22, the UL processing time 23, the DL processing time 24, and the total processing time 25. Namely, the analyzing unit 123 decides combinations of feasible maximum rates in the UL and the DL in each of which the available CPU resource percentage 20 is equal to or less than 95.0%.

For example, it is assumed that the available CPU resource percentage 20 is 70.0%. In this case, the analyzing unit 123 generates the analysis information 30 indicating combinations of sets of the available CPU resource percentage 20 that is equal to or less than 70.0%, the UL data rate 21, the DL data rate 22, the UL processing time 23, the DL processing time 24, and the total processing time 25. Namely, the analyzing unit 123 decides the combinations of feasible maximum rates in the UL and the DL in each of which the available CPU resource percentage 20 is equal to or less than 70.0% (see (A) illustrated in FIG. 8).

Because the analyzing unit 123 generates the analysis information 30 based on the server information 10 and the processing time collected by the collecting unit 112, the analysis information 30 is updated at intervals of predetermined time (for example, 10 ms). The analyzing unit 123 outputs the updated analysis information 30 to the MAC scheduler 121.

The data rate deciding unit 122 in the MAC scheduler 121 receives the analysis information 30 output from the analyzing unit 123. The data rate deciding unit 122 refers to the analysis information 30 and decides a single combination of the UL data rate 21 and the DL data rate 22 from among the combinations of sets of the UL data rate 21 and the DL data rate 22. The data rate deciding unit 122 is an example of a “second deciding unit”. Consequently, the MAC scheduler 121 performs scheduling of UL and DL communication between the base station device 100 and the user equipment 200 so as not to exceed the decided UL data rate 21 and the DL data rate 22.

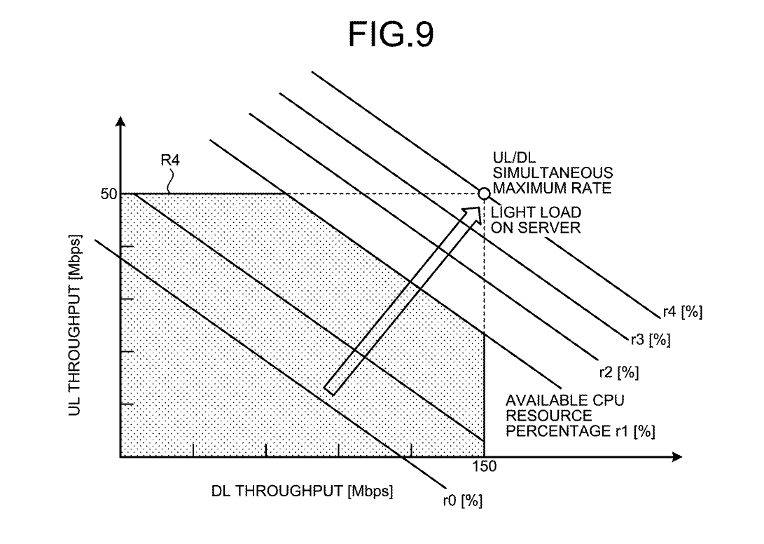

FIG. 9 is a diagram illustrating the relationship between UL throughput and DL throughput in the base station device 100 according to the embodiment. In FIG. 9, the horizontal axis represents throughput [Mbps] in a DL and the maximum value of the data rate used for communication in the DL is 150 Mbps. The vertical axis represents throughput [Mbps] in an UL and the maximum value of the data rate used for communication in the UL is 50 Mbps.

As described above, in the layer 1, the collecting unit 112 collects the server information 10 and the processing time at intervals of predetermined time (for example, 10 ms); the analyzing unit 123 generates, in the layer 2, the analysis information 30 based on the collected server information 10 and the processing time; and updates the analysis information 30 at intervals of predetermined time. Thus, as illustrated in FIG. 9, a region R4 in which the UL and the DL are simultaneously used at the maximum rate by the available CPU resource percentage 20 varies every time the analysis information 30 is updated. For example, if the available CPU resource percentage 20 is represented by available CPU resource percentages r0 to r4 illustrated in FIG. 9, the region R4 varies in accordance with the available CPU resource percentages r0 to r4.

The magnitude relationship between the available CPU resource percentages r0 to r4 is r0<r1<r2<r3<r4. For example, it is assumed that the available CPU resource percentages r0, r1, r2, r3, and r4 are 40%, 70%, 80%, 90%, and 100%, respectively. Namely, the size of the region R4 is increased as the load applied to the general purpose server is decreased and, based on the UL data rate 21 and the DL data rate 22 that are decided based on the region R4 in this state, communication in the UL and the DL is scheduled. In contrast, the size of the region R4 is decreased as the load applied to the general purpose server is increased and, based on the UL data rate 21 and the DL data rate 22 that are decided based on the region R4 in this state, communication in the UL and the DL is scheduled.

Process Performed by the Base Station Device 100

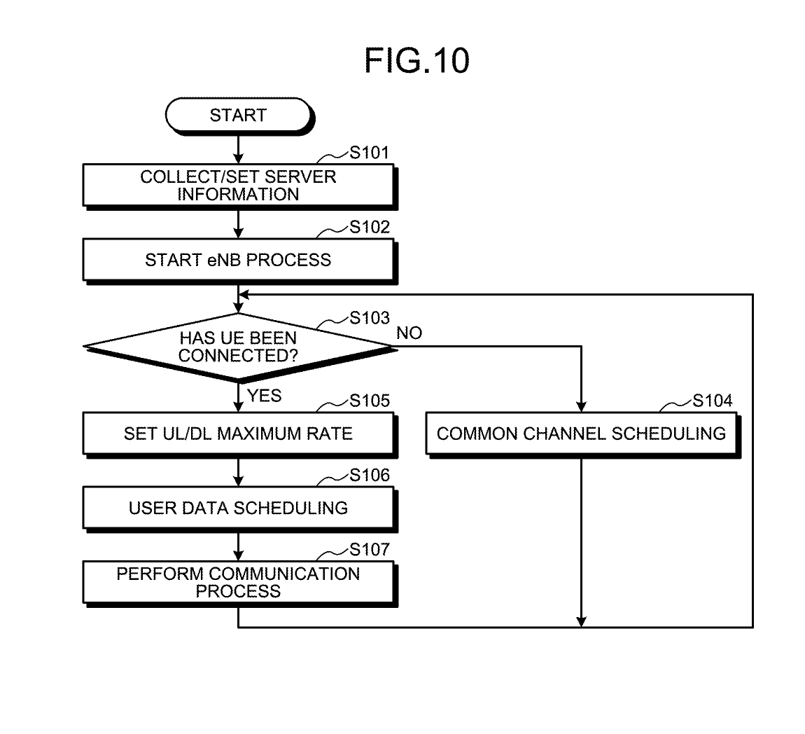

FIG. 10 is a flowchart illustrating an example of a process performed by the base station device 100 according to the embodiment.

First, in the layer 1, the collecting unit 112 collects the server information 10 and the processing time. Then, in the layer 2, the analyzing unit 123 generates (sets) the analysis information 30 based on the server information 10 and the processing time collected by the collecting unit 112 (Step S101).

Then, the process performed by the base station device 100 (eNB) is started (Step S102). In LTE communication, in the ULs and the DLs, common channels that are radio resources (physical channels) common to a plurality of pieces of the user equipment 200(UE) are used.

It is assumed that the base station device 100 and the user equipment 200 are not connected (No at Step S103). In this case, in the layer 2, the MAC scheduler 121 in the MAC layer 120 performs scheduling that decides which one of the pieces of the user equipment 200 uses which channel (Step S104). Then, the process performed by the base station device 100 returns to Step S103.

In contrast, it is assumed that the base station device 100 and the user equipment 200 are connected (Yes at Step S103). In this case, the data rate deciding unit 122 in the MAC scheduler 121 refers to the analysis information 30 and decides a single combination of the UL data rate 21 and DL data rate 22 from among the combinations of sets of the UL data rate 21 and the DL data rate 22. Namely, the data rate deciding unit 122 sets the maximum rate that is simultaneously feasible in both the UL and the DL at the available CPU resource percentage 20 (Step S105).

By doing so, the MAC scheduler 121 performs scheduling of UL and DL communication between the base station device 100 and the user equipment 200 so as not to exceed the decided UL data rate 21 and the DL data rate 22. Namely, the MAC scheduler 121 performs scheduling that decides which user data sends to which one of the pieces of the user equipment 200 (Step S106). Then, the PHY layer 111 in the layer 1 performs communication in accordance with the scheduling (Step S107). Thereafter, the process performed by the base station device 100 returns to Step S103.

Furthermore, the collecting unit 112 collects the server information 10 and the processing time at intervals of predetermined time (for example, 10 ms) and the analyzing unit 123 generates the analysis information 30 based on the server information 10 and the processing time collected by the collecting unit 112. Consequently, the analysis information 30 is updated at intervals of predetermined time (in this case, 10 ms).

Here, the process performed at Step S105 will be described in detail. Namely, a description will be given of a method in which the data rate deciding unit 122 in the MAC scheduler 121 decides a single combination of the UL data rate 21 and the DL data rate 22 from among the combinations of sets of the UL data rate 21 and the DL data rate 22.

Method for Deciding the First Data Rate

First, in a method for deciding the first data rate, the ratio of the data buffer retention volumes in the UL and the DL.

As described above, in the layer 2, a notification of a retention volume of data that is stored in the buffer in each of the pieces of the user equipment 200 is sent to the MAC layer 120 as the data buffer retention volume in the UL from each of the pieces of the user equipment 200 via the layer 1. Furthermore, a notification of a retention volume of data that is stored in the buffer (buffers in the PDCP layer 140 and the RLC layer 130) in a higher layer of the MAC layer 120 is sent to the MAC layer 120 from the RLC layer 130 as the data buffer retention volume in the DL.

Thus, at Step S105, the data rate deciding unit 122 in the MAC scheduler 121 in the MAC layer 120 calculates the ratio of the data buffer retention volume in the UL to the data buffer retention volume in the DL. The data rate deciding unit 122 decides, from among the combinations of sets of the UL data rate 21 and the DL data rate 22, the UL data rate 21 and the DL data rate 22 that are in accordance with the calculated ratio as a single combination of the UL data rate 21 and the DL data rate 22. Then, at Step S106, the MAC scheduler 121 performs scheduling of UL and DL communication so as not to exceed the decided UL data rate 21 and the DL data rate 22.

For example, it is assumed that the available CPU resource percentage 20 analyzed by the analyzing unit 123 is 70.0% (see the available CPU resource percentage r1 illustrated in FIG. 9). In this case, the analyzing unit 123 generates the analysis information 30 indicating the combinations of sets of the available CPU resource percentage 20 that is equal to or less than 70.0%, the UL data rate 21, the DL data rate 22, the UL processing time 23, the DL processing time 24, and the total processing time 25. Namely, the analyzing unit 123 decides combinations of the data rate in feasible UL and DL in each of which the available CPU resource percentage 20 is equal to or less than 70.0% (see (A) illustrated in FIG. 8).

Here, for example, it is assumed that, from among the combinations of sets of the UL data rate 21 and the DL data rate 22, the ratio of the UL data rate 21 of “6 Mbps” to the DL data rate 22 of “150 Mbps” corresponds to the calculated ratio described above. In this case, at Step S105, the data rate deciding unit 122 decides the UL data rate 21 of “6 Mbps” and the DL data rate 22 of “150 Mbps” as the UL data rate 21 and the DL data rate 22 that are in accordance with the calculated ratio. Then, at Step S106, the MAC scheduler 121 performs scheduling of UL and DL communication so as not to exceed the UL data rate 21 of “6 Mbps” and the DL data rate 22 of “150 Mbps” that have been decided.

Furthermore, in the method for deciding the data rate described above, the ratio of the data buffer retention volumes in the UL and the DL has been considered; however, it may also possible consider a difference between transmission speeds in the UL and the DL.

Method for Deciding the Second Data Rate

In the method for deciding the second data rate, the ratio of the quality of radio channels in the UL and the DL is used.

As described above, in layer 1, when the PHY layer 111 receives a radio signal sent from the user equipment 200, the PHY layer 111 performs FFT on the received radio signal, thereby the received radio signal is subjected to OFDM demodulation. In the signal that has been subjected to OFDM demodulation by the PHY layer 111, data (the user data and the control data), a pilot signal (the reference signal), and the like are included. The PHY layer 111 measures the quality of radio channel based on the extracted pilot signal. Hereinafter, the quality of the measured radio channel is referred to as “first radio channel quality”. The first radio channel quality is a reference signal received quality (RSRQ) used in, for example, LTE. The first radio channel quality is represented by a value. The PHY layer 111 notifies the MAC layer 120 in the layer 2 of the first radio channel quality. The first radio channel quality is an example of the “first communication quality”.

Furthermore, as described above, information, such as the data buffer retention volume in the UL, the radio channel quality (CQI), and the like, is included in the signal that has been subjected to OFDM demodulation by the PHY layer 111. Hereinafter, the radio channel quality included in the signal subjected to OFDM demodulation is referred to as the “second radio channel quality”. The second radio channel quality is represented by a value. The PHY layer 111 notifies the MAC layer 120 in the layer 2 of the second radio channel quality. The second radio channel quality is an example of the “second communication quality”.

Thus, at Step S105, the data rate deciding unit 122 in the MAC scheduler 121 in the MAC layer 120 calculates the ratio of the value indicating the first radio channel quality to the value indicating the second radio channel quality. The data rate deciding unit 122 decides, from among the combinations of sets of the UL data rate 21 and the DL data rate 22, the UL data rate 21 and the DL data rate 22 that are in accordance with the calculated ratio as a single combination of the UL data rate 21 and the DL data rate 22 described above. Thereafter, at Step S106, the MAC scheduler 121 performs scheduling of UL and DL communication so as not to exceed the decided UL data rate 21 and the DL data rate 22.

For example, it is assumed that the available CPU resource percentage 20 analyzed by the analyzing unit 123 is 70.0% (see the available CPU resource percentage r1 illustrated in FIG. 9). In this case, the analyzing unit 123 generates the analysis information 30 indicating the combinations of sets of the available CPU resource percentage 20 that is equal to or less than 70.0%, the UL data rate 21, the DL data rate 22, the UL processing time 23, the DL processing time 24, and the total processing time 25. Namely, the analyzing unit 123 decides the combinations of feasible maximum rates in the UL and the DL in each of which the available CPU resource percentage 20 is equal to or less than 70.0% (see (A) illustrated in FIG. 8).

Here, for example, it is assumed that the ratio of the UL data rate 21 of “6 Mbps” to the DL data rate 22 of “144 Mbps” corresponds to the calculated ratio described above. In this case, at Step S105, the data rate deciding unit 122 decides the UL data rate 21 of “6 Mbps” and the DL data rate 22 of “144 Mbps” as the UL data rate 21 and the DL data rate 22 that are in accordance with the calculated ratio. Then, at Step S106, the MAC scheduler 121 performs scheduling of UL and DL communication so as not to exceed the UL data rate 21 of “6 Mbps” and the DL data rate 22 of “144 Mbps” that have been decided.

Method of Deciding a Third Data Rate

As described above, it is preferable that the number of usage patterns of the user equipment 200 used in DL communication be greater than that used in UL communication. Based on this, in the method for deciding the third data rate, in contrast to the methods for deciding the first rate and the second data rate, the UL data rate 21 is set to a fixed value from among the combinations of sets of the UL data rate 21 and the DL data rate 22. In the method of deciding the third data rate, for example, a description will be given of a portion that has been modified from the method of deciding the first data rate.

For example, the available CPU resource percentage 20 analyzed by the analyzing unit 123 is 70.0% (see the available CPU resource percentage r1 illustrated in FIG. 9). Furthermore, by considering that the number of usage patterns of the user equipment 200 in DL communication is greater than that in UL communication, for example, the UL data rate 21 is set to 6 Mbps. In this case, the analyzing unit 123 generates the analysis information 30 indicating the combinations of sets of the available CPU resource percentage 20, the UL data rate 21 that is 6 Mbps, the DL data rate 22, the UL processing time 23, the DL processing time 24, and the total processing time 25. Namely, the analyzing unit 123 decides the combinations of feasible maximum rates in the UL and the DL in each of which the available CPU resource percentage 20 is equal to or less than 70.0% when the UL data rate 21 is set to 6 Mbps (see (B) illustrated in FIG. 8).

Here, for example, it is assumed that, from among the combinations of sets of the UL data rate 21 and the DL data rate 22, the ratio of the UL data rate 21 of “6 Mbps” to the DL data rate 22 of “150 Mbps” corresponds to the calculated ratio described above. In this case, at Step S105, the data rate deciding unit 122 decides the UL data rate 21 of “6 Mbps” and the DL data rate 22 of “150 Mbps” as the UL data rate 21 and the DL data rate 22 that are in accordance with the calculated ratio. Then, at Step S106, the MAC scheduler 121 performs scheduling of UL and DL communication so as not to exceeds the UL data rate 21 of “6 Mbps” and the DL data rate 22 of “150 Mbps” that have been decided.

Method of Deciding a Fourth Data Rate

In the method of deciding a fourth data rate, by obtaining the average value of free space in the CPU resources (the available CPU resource percentage 20) in the general purpose server that was used in the past, it is possible to estimate the available CPU resource percentage 20 that is to be used next time. In the method of deciding a fourth data rate, for example, a description will be given of a portion that has been modified from the method of deciding the third data rate.

For example, the available CPU resource percentage 20 analyzed by the analyzing unit 123 is 70.0% (see the available CPU resource percentage r1 illustrated in FIG. 9). Furthermore, by considering that the number of usage patterns of the user equipment 200 in DL communication is greater than that in UL communication, for example, the UL data rate 21 is set to 6 Mbps. In this case, the analyzing unit 123 generates the analysis information 30 indicating the combinations of sets of the available CPU resource percentage 20, the UL data rate 21 that is 6 Mbps, the DL data rate 22, the UL processing time 23, the DL processing time 24, and the total processing time 25. Namely, the analyzing unit 123 decides the combinations of feasible maximum rates in the UL and the DL in each of which the available CPU resource percentage 20 is equal to or less than 70.0% when the UL data rate 21 is set to 6 Mbps (see (B) illustrated in FIG. 8).

Furthermore, it is assumed that, in a certain time zone (set time), the available CPU resource percentage 20 has been analyzed by the analyzing unit 123 three times and scheduling has been performed by the MAC scheduler 121 three times. For example, in the first scheduling, as the combinations of the maximum rate in the ULs and the DLs with respect to the available CPU resource percentage 20 of “62.0%”, the UL data rate 21 of “6 Mbps” and the DL data rate 22 of “150 Mbps” are used. In the second scheduling, as the combinations of the maximum rates in the ULs and the DLs with respect to the available CPU resource percentage 20 of “60.5%”, the UL data rate 21 of “6 Mbps” and the DL data rate 22 of “144 Mbps” are used. In the third scheduling, as the combinations of the maximum rates in the ULs and the DLs with respect to the available CPU resource percentage 20 of “59.0%”, the UL data rate 21 of “6 Mbps” and the DL data rate 22 of “138 Mbps” are used.

Here, at Step S105, the data rate deciding unit 122 calculates the average value of the available CPU resource percentage 20 of “62.0%”, “60.5%”, and “59.0%” that were used in the past. In this case, the average value of the available CPU resource percentage 20 is 60.5%. The data rate deciding unit 122 selects, from among the combinations of sets of the UL data rate 21 and the DL data rate 22, the UL data rate 21 of “6 Mbps” and the DL data rate 22 of “144 Mbps” that are associated with the average value “60.5%” described above. Namely, the data rate deciding unit 122 decides the UL data rate 21 of “6 Mbps” and the DL data rate 22 of “144 Mbps” that are associated with the average value “60.5%” described above as a single combination of the UL data rate 21 and the DL data rate 22. Then, at Step S106, the MAC scheduler 121 performs scheduling of UL and DL communication so as not to exceed the UL data rate 21 of “6 Mbps” and the DL data rate 22 of “144 Mbps” that have been decided.

Effects

As described above, the base station device 100 according to the embodiment is the base station device that is implemented on a general purpose server by using software and includes the collecting unit 112, the first deciding unit (the analyzing unit 123), and the scheduler (the MAC scheduler 121). The collecting unit 112 collects information (the server information 10) indicating the usage states of the resources in the general purpose server. The analyzing unit 123 decides, based on the collected server information 10, combinations of the maximum rates (the UL data rate 21 and the DL data rate 22) in the ULs and the DLs that are feasible in free space in the CPU resources (at the available CPU resource percentage 20) in the general purpose server. The MAC scheduler 121 adjusts (scheduling) communication with the user equipment 200 in the UL and the DL so as not to exceed the maximum rate of a single combination of the UL and the DL from among the combinations of the maximum rates (the UL data rate 21 and the DL data rate 22) in the ULs and the DLs.

When the base station device 100 is implemented on the general purpose server by using software, it is conceivable to use the general purpose server as, for example, a data center. Namely, in addition to the processes performed by the base station device 100, there may also be a case in which the processes to be performed by the data center are allowed to perform in the general purpose server. In this case, there may sometimes be a case in which CPU resources that can be used by the base station device 100 conceivably vary.

In contrast, the base station device 100 according to the embodiment decides, if the CPU resources vary, combinations of maximum rates (the UL data rate 21 and the DL data rate 22) in the ULs and the DLs that are feasible in free space in the CPU resources. Then, the base station device 100 according to the embodiment performs scheduling of UL and DL communication so as not to exceed the maximum rate of a single combination of the UL and the DL from among the combinations of the maximum rates (the UL data rate 21 and the DL data rate 22) in the ULs and the DLs. Consequently, in the base station device 100 according to the embodiment efficiently utilizes the CPU resources.

The base station device 100 according to the embodiment further includes the second deciding unit (the data rate deciding unit 122). The data rate deciding unit 122 calculates the ratio of a data buffer retention volume in the UL to a data buffer retention volume in the DL. The data buffer retention volume in the UL is a retention volume of data stored in a buffer in the user equipment 200 and is notified from the user equipment 200. The data buffer retention volume in the DL is a retention volume of data stored in a buffer in the base station device 100. The data rate deciding unit 122 decides, from among the combinations of the maximum rates (the UL data rate 21 and the DL data rate 22) in the ULs and the DLs, a combination of the maximum rate in the UL and the DL that are in accordance with the calculated ratio as a single combination of the maximum rates in the UL and the DL. Then, the MAC scheduler 121 performs scheduling of UL and DL communication so as not to exceed the maximum rates that are in accordance with the calculated ratio. Consequently, in the base station device 100 according to the embodiment, even if CPU resources vary, it is possible to efficiently utilize the CPU resources.

In the base station device 100 according to the embodiment, the data rate deciding unit 122 calculates the ratio of the value that indicates the first communication quality obtained when the signal sent from the user equipment 200 is measured to the value that indicates the second communication quality that is sent from the user equipment 200 as a notification. The data rate deciding unit 122 decides, from among the combinations of the maximum rates (the UL data rate 21 and the DL data rate 22) in the ULs and the DLs, the maximum rate in the UL and the DL that are in accordance with the calculated ratio as a single combination of the maximum rates in the UL and the DL. Then, the MAC scheduler 121 performs scheduling UL and DL communication so as not to exceed the maximum rates that are in accordance with the calculated ratio. Consequently, in the base station device 100 according to the embodiment, even if CPU resources vary, it is possible to efficiently utilize the CPU resources.

In the base station device 100 according to the embodiment, the number of usage patterns of the user equipment 200 used in DL communication is greater than that in UL communication. Thus, the base station device 100 according to the embodiment sets, by considering the usage patterns of the user equipment 200, the UL data rate 21 to a fixed value from among the combinations of the maximum rates (the UL data rate 21 and the DL data rate 22) in the ULs and the DLs. In this way, in the base station device 100 according to the embodiment, even if CPU resources vary, it is possible to efficiently utilize the CPU resources in accordance with the usage patterns of the user equipment 200.

In the base station device 100 according to the embodiment, the data rate deciding unit 122 calculates the average value of free space in the CPU resources (the available CPU resource percentage 20) that are used in the past. The data rate deciding unit 122 selects, from among the combinations of the maximum rates (the UL data rate 21 and the DL data rate 22) in the ULs and the DLs, the maximum rates in the ULs and the DLs associated with the average value of the available CPU resource percentage 20. Namely, the data rate deciding unit 122 decides the maximum rate, in the UL and the DL, associated with the average value of the available CPU resource percentage 20 as the maximum rate of a single combination of the UL and the DL. Then, the MAC scheduler 121 performs scheduling of UL and DL communication so as not to exceed the maximum rate that is in accordance with the calculated ratio. Consequently, in the base station device 100 according to the embodiment, even if CPU resources vary, it is possible to efficiently utilize the CPU resources. Furthermore, in the base station device 100 according to the embodiment, by obtaining the average value described above, it is possible to estimate the available CPU resource percentage 20 that is to be used next time.

According to an aspect of an embodiment, it is possible to efficiently utilize the resources.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station device implemented on a general purpose server by using software, the base station device comprising:
a memory; and
a processor coupled to the memory, wherein the processor executes a process comprising:
collecting information indicating usage states of resources in the general purpose server;
deciding, based on the collected information, combinations of uplink data rates and downlink data rates that are feasible in free space in the resources in the general purpose server; and
adjusting communication with user equipment so as not to exceed a combination of an uplink data rate and a downlink data rate out of the combinations of the uplink data rates and the downlink data rates.

2. The base station device according to claim 1, wherein the process further comprises:
calculating a ratio of an uplink data buffer retention volume, which is a retention volume of data stored in a buffer in the user equipment and is notified from the user equipment, to a downlink data buffer retention volume, which is a retention volume of data stored in a buffer in the base station device; and
deciding, from among the combinations of the uplink data rates and the downlink data rates, an uplink data rate and a downlink data rate that are in accordance with the calculated ratio as the combination of the uplink data rate and the downlink data rate.

3. The base station device according to claim 1, wherein the process further comprises:
calculating a ratio of a value, which indicates first communication quality that is obtained when a signal sent from the user equipment is measured, to a value, which indicates second communication quality that is notified from the user equipment; and
deciding, from among the combinations of the uplink data rates and the downlink data rates, an uplink data rate and a downlink data rate that are in accordance with the calculated ratio as the combination of the uplink data rate and the downlink data rate.

4. The base station device according to claim 1, wherein the process further comprises:
calculating an average value of free space in the resources used in past; and
deciding, from among the combinations of the uplink data rates and the downlink data rates, an uplink data rate and a downlink data rate associated with the average value of the free space in the resources as the combination of the uplink data rate and the downlink data rate.

5. The base station device according to claim 1, wherein an uplink data rate from among the combinations of the uplink data rates and the downlink data rates is set to a fixed value.

6. A control method for a base station device implemented on a general purpose server by using software, the control method comprising:
collecting information indicating usage states of resources in the general purpose server, by a processor;
deciding, based on the collected information, combinations of uplink data rates and downlink data rates that are feasible in free space in the resources in the general purpose server, by the processor; and
adjusting communication with user equipment so as not to exceed a combination of an uplink data rate and a downlink data rate out of the combinations of the uplink data rates and the downlink data rates, by the processor.
